(19) United States
(12) Patent Application Publication
(10) Pub. No.: US 2004/0201452 A1
(43) Pub. Date: Oct. 14, 2004

(54) Patron locating methods, systems and devices

(76) Inventor: David P. Fisher, Miamisburg, OH (US)

Correspondence Address: NIXON & VANDERHYE, PC, 1100 N GLEBE ROAD, 8TH FLOOR, ARLINGTON, VA, 22201-4714, US

(21) Appl. No.: 10/412,283

(22) Filed: Apr. 14, 2003

(51) Int. Cl. H04Q 7/00

(52) U.S. Cl. 340/7.63

(57) ABSTRACT

A wireless system for locating patrons or customers is provided, the locating system including a wireless paging activator, one or more wireless pagers adapted to receive an identifying signal from the wireless paging activator and a plurality of a plurality of pager-caddies adapted to hold the wireless pagers, each pager-caddy affixed to a respective fixture located in a localized area, such as a restaurant, and each pager-caddy further adapted to temporarily hold a pager in a conspicuous location. In various embodiments, the locating system can rely less on visibility of the pager and alternatively use a transponder-based system that relies in part on a return signal generated by an activated transponder to provide at least a generalized a location of the transponder.

### FIELD OF THE INVENTION

This invention relates to methods, systems and devices for locating patrons in a localized area, such as a restaurant.

### BACKGROUND OF THE INVENTION

Often in service-related businesses, such as restaurants, customers are required to wait for seating or services. As a result, various employees of the business are required to later locate these customers. For example, a restaurant having a timely wait for seating must record each prospective customer's name in a log book, then contact each customer as seating becomes available. Similarly, other restaurants that require a customer to order from a cashier or other central location, then allow the customer to seat himself must later contact or locate the customer to deliver his order as it becomes available.

One method that restaurants use to contact customers or prospective customers is to hand each customer a pager, such as the pager 100 shown in FIG. 1A. These pagers 100 generally consist of a body 110 that houses a wireless radio receiver, a display 120 capable of providing a short message (or alternatively a beeper or buzzer encased in the body 110) and an advertising portion 130 that serves as advertising space while incidentally reducing the occurrence of pager loss or misplacement. Unfortunately, such pagers are not always effective in various social environments where a patron's attention is often distracted.

To improve customer response, a more visible/highly luminescent type of radio pager, e.g., Glowster® (JTech Communications, Inc, Boca Raton, Fla.), was developed. FIG. 1B depicts a Glowster 150 having a generally translucent and disk-shaped body 160, a number of light emitting diodes (LEDs) 162 encased within the body 160 that light up when the Glowster is activated and a flattened central portion 164 suitable to set a drink upon. While the Glowster 150 of FIG. 2 provides a better instrument to signal a customer (or prospective customer), often it is in the interest of the restaurant to actively seek out the customer, as opposed to wait for the customer to respond to an activated pager. Accordingly, a need still exists for new methods and systems designed to locate customers and prospective customers.

### SUMMARY OF THE INVENTION

It is an object of the present invention to provide methods and systems for locating people in a localized area, such as a restaurant. To achieve this and other objects, a wireless system for locating patrons is provided, the locating system including a wireless paging activator, one or more wireless pagers adapted to receive an identifying code from the wireless paging activator and a plurality of pager-caddies adapted to hold the wireless pagers with each pager-caddy affixed (i.e., attached, joined, fastened to or incorporated into) to a respective fixture located in a localized area, such as a restaurant, and each pager-caddy further adapted to temporarily hold a pager in a conspicuous location.

For pagers generally configured as coasters and/or having luminescent displays, the present invention provides an added measure of conspicuousness to the pager by allowing the pager to be seen from far greater distances than if the pager were merely set on a table and used as intended, i.e., as a coaster.

In other embodiments, the locating system can use a transponder-based system that relies in part on a return signal generated by an activated transponder to provide at least a generalized a location of the transponder. Such transponders can be incorporated into conventional pagers. Alternatively, such transponders can take the form of a battery-less Radio-Frequency Identification Device (RFID) or similar device that can be manufactured for a tiny percentage of the cost of a conventional pager or transponder.

Additional non-limiting objects and attendant advantages of the present invention will be set forth, in part, in the following drawings and description, or may be learned or become apparent from practicing or using the present invention. The objects and advantages of the present invention may be realized and attained by means of the features and methods pointed out in the appended claims, which are incorporated into this description by reference. It is to be understood that the foregoing general description and the following detailed description are exemplary and explanatory only and are not to be viewed as being restrictive of the invention, as claimed.

### DESCRIPTION OF THE DRAWINGS

The invention is described in detail with regard to the following figures, wherein like numerals reference like elements, and wherein:

FIGS. 1A and 1B depict conventional pagers;

FIG. 2 depicts an exemplary floorplan/layout according to the present invention;

FIG. 3 depicts an exemplary pager with a first securing means according to the present invention;

FIG. 4A depicts an exemplary pager with a second securing means according to the present invention;

FIG. 4B depicts an exemplary pager with a securing means incorporated into a condiment caddy;

FIG. 5A depict an exemplary pager with a third securing means according to the present invention;

FIG. 5B depicts an exemplary pager with a third securing means incorporated into a condiment caddy;

FIG. 6 depicts a second exemplary floorplan/layout according to the present invention;

FIGS. 7A and 7B depict a transponder operation according to the present invention;

FIG. 8 is a block diagram of a first low-cost transponder according to the present invention;

FIG. 9 is a block diagram of a second low-cost transponder according to the present invention; and

FIG. 10 depicts a portion of the transponder of FIG. 9.

### DESCRIPTION OF PREFERRED EMBODIMENTS

All patents, patent applications and literatures cited in this description are incorporated herein by reference in their entirety. In the case of inconsistencies, the present disclosure, including definitions, will control.

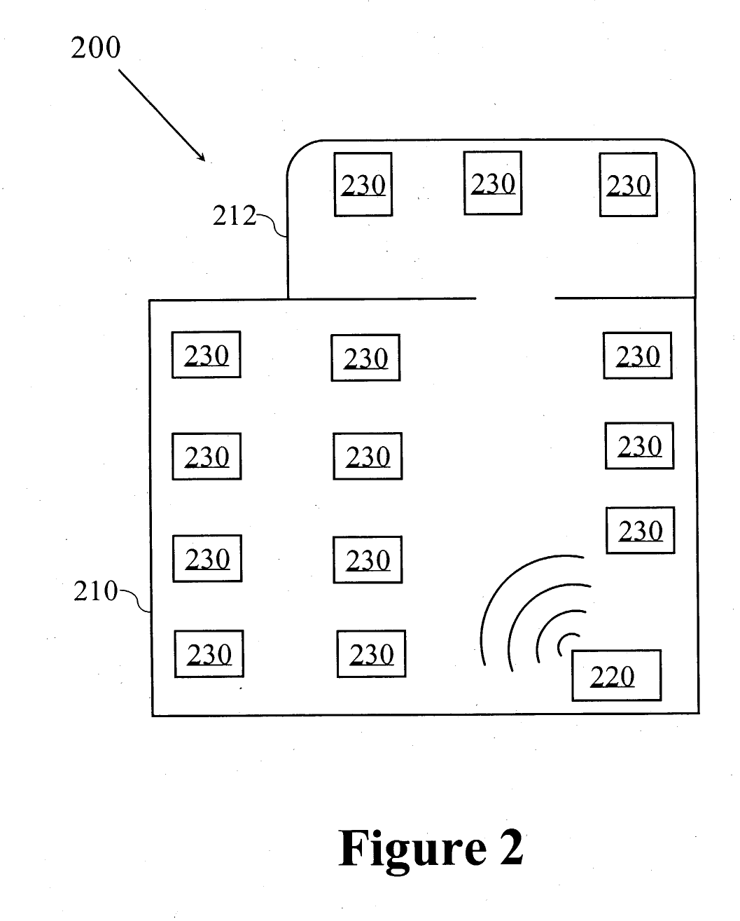

FIG. 2 depicts an exemplary floor plan 200 with integrated location system according to the present invention. As shown in FIG. 2, the floor plan 200 includes a first room 210 and an outdoor courtyard 212 with a number of tables 230 distributed throughout. A station 220 suitable for servicing patrons is also provided. In various embodiments, the station 220 can be a hostess station for prospective customers waiting to be seated. In other embodiments, the station 220 can be configured to service customers that have ordered a service or product at the station 220 and are waiting for service/product fulfillment at any of the tables 230. However, it should be appreciated that in various embodiments the station 220 and invention in general can be associated with any business where customer queues occur.

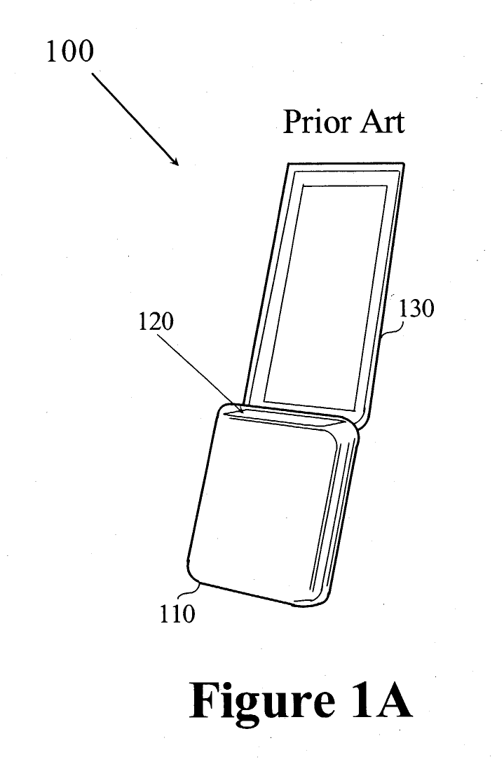

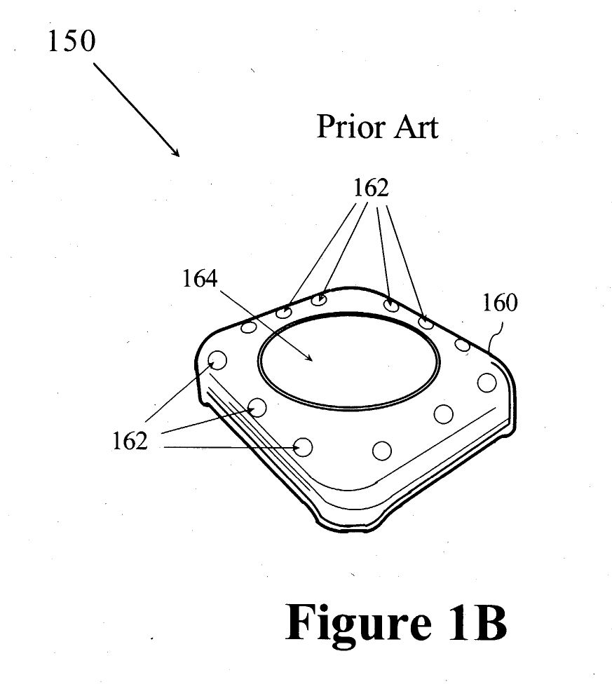

The exemplary station 200 includes an integral wireless paging activator capable of causing a wireless signal to be provided to one or more wireless pagers located within the floorplan 200 in order to activate a particular pager. The wireless pagers (not shown) can be portable electronic pagers, such as those found in FIGS. 1A and 1B, and can be configured to activate upon receiving a predetermined identifying signal from the wireless paging activator thus providing a conspicuous signal to both the patron possessing the activated pager as well as one or more employees servicing the patrons.

In order to provide a more conspicuous signal, the exemplary pagers include a number of highly visible luminescent displays, such as LEDs, configured to flash in various patterns as well as provide optional auditory cues, e.g., audible beeping or playing recorded messages. However, the particular configuration of the pagers can vary as long as they are capable of generating conspicuous visual cues at appreciable distances, i.e., distances extending beyond the personal reach of a patron possessing the pager.

While the disk/coaster shaped Glowster of FIG. 1B may be used to provide conspicuous visual signals, it should be appreciated that the Glowster's very configuration as a coaster generally leads patrons to place their Glowsters on a table or other flat surface and then partially cover the Glowster with a drink, thus reducing appreciable visibility.

However, the present invention provides a convenient alternative to the natural table-top position of Glowster-type pagers to consequently provide the pager with improved visibility. That is, by providing a number of elevated pager-caddies adapted to hold pagers with each pager-caddy affixed to any of various available fixtures conveniently located close to a patron, such pagers will be more conspicuous with respect to parties interested in serving the patrons.

For the purposes of this disclosure, a pager-caddy can be any device configured to hold or secure a pager to another object. Typically, pager-caddies take the form of clip-type devices that secure pagers to belts, the lips of inner suit pockets or some other article of clothing because pagers are devices designed for personal use, and therefore pager-caddies are not generally configured to secure pagers to articles other than clothing. However, the present invention provides a unique advantage in that it provides pager-caddies capable of securing pagers to fixtures, such as a wall, a condiment-caddy (a device restaurants often use to hold a variety of condiments), a food caddy, overhanging lamps, an extension-fixture affixed to a table or booth, any other structure capable of securing a pager at an elevation high enough to increase conspicuousness, and the like.

In operation, a business using the present invention will start by distributing a pager or some other form of wireless electronic receiver to each visiting patron. Each patron is then considered to have located himself randomly somewhere in the floorplan area and place the pager/receiver in a nearby pager-caddy. Upon the need to contact a particular patron, an operator (e.g., a hostess or waiter) can activate the wireless paging activator to emit a signal containing an identifying code of the particular pager/receiver possessed by the patron of interest. The appropriate pager will then activate with the activated pager emitting a visible signal in conspicuous view of the operator such that the patron of interest can be quickly located.

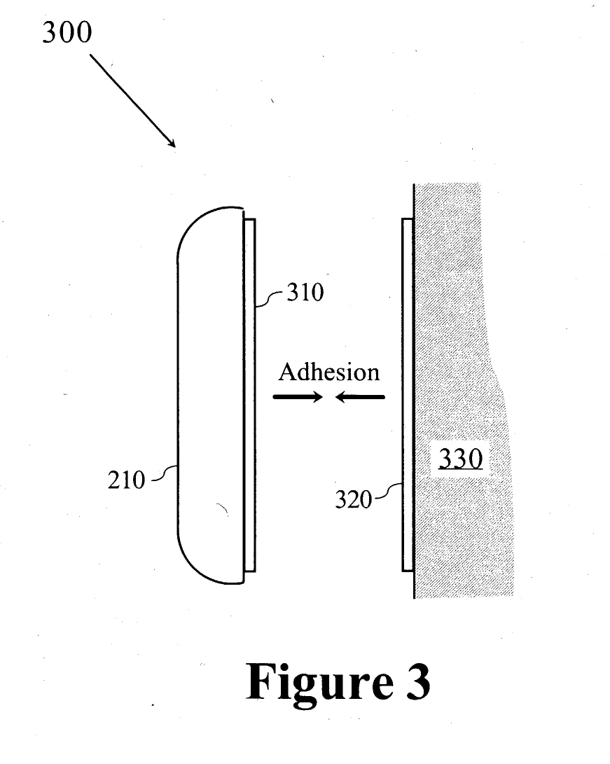

FIG. 3 depicts a first pager-caddy 300 according to the present invention capable of enabling a business patron (or other individual) to conveniently and temporarily secure a paging device to a fixture. As shown in FIG. 3, a pager 210 having an attached magnetic strip 310 can be magnetically secured to a wall 330 having a metal portion 320. While the exemplary caddy 300 uses a pager 210 having an attached magnetic strip 310, it should be appreciated that any magnetic arrangement may alternatively be used, such as using a metal plate used with pager 210 and using a magnetic portion on wall 330, using two magnets, using electro-magnets etc. Further, as discussed above, fixtures other than walls can be used to secure pager 210, such as condiment caddies, overhanging light-fixtures or specially-made structures.

While the exemplary pager-caddy 300 of FIG. 3 may use a magnetic means to secure the pager 210, it should be appreciated that other conventional or later-developed adhesive means can be alternatively used, such as a grappling material (e.g., velcro), suction cups and so forth without departing from the spirit and scope of the present invention.

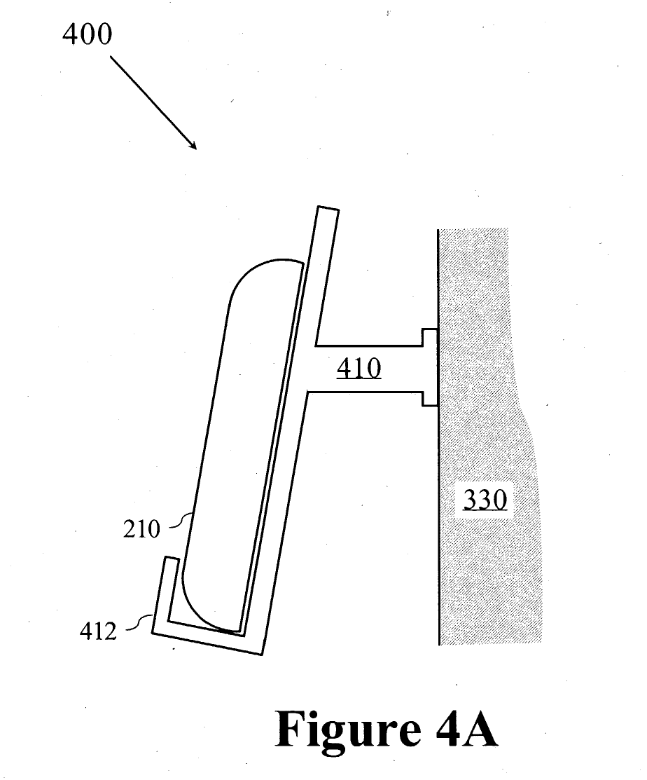

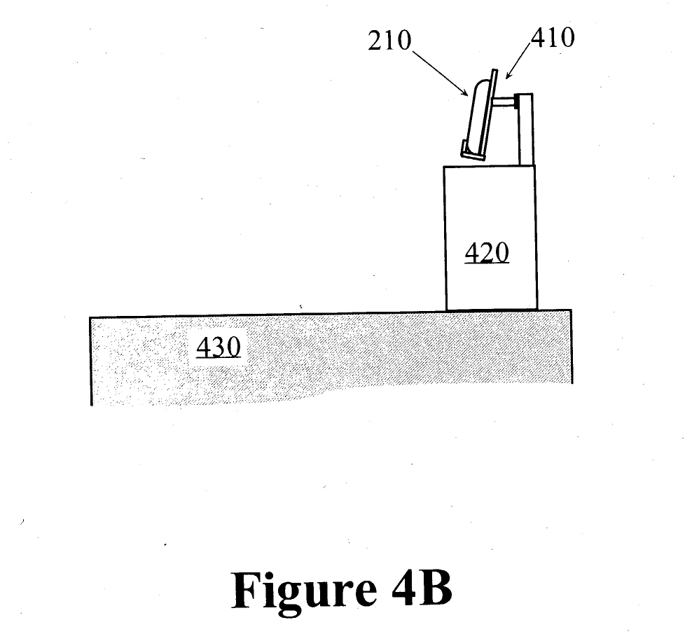

FIG. 4A depicts a second pager securing arrangement 400 according to the present invention capable of enabling a business patron or other individual to conveniently and temporarily secure a paging device to a fixture. As shown in FIG. 4A, pager 210 is not adhered to wall 330, but secured via a specially designed pager-caddy 410 having a securing lip 412. While the second exemplary pager-caddy 410 uses a lipped structure to secure the pager 210, it should be appreciated that other mechanical configurations can be used, such as clips, pegs, cup-like structures or other conventional or later developed mechanical securing means without departing from the spirit and scope of the present invention.

FIG. 4B depicts the pager-caddy 410 of FIG. 4A integrated into a condiment-caddy 420 with the condiment-caddy 420 resting on surface 430, which can be a dining table, a bar or any other useful surface likely found in a restaurant. FIG. 4B serves to illustrate that a pager-caddy can be integrated into practically any accessory found in a place of business to elevate a Glowster or other like pager to a conspicuous location without departing from the spirit and scope of the present invention.

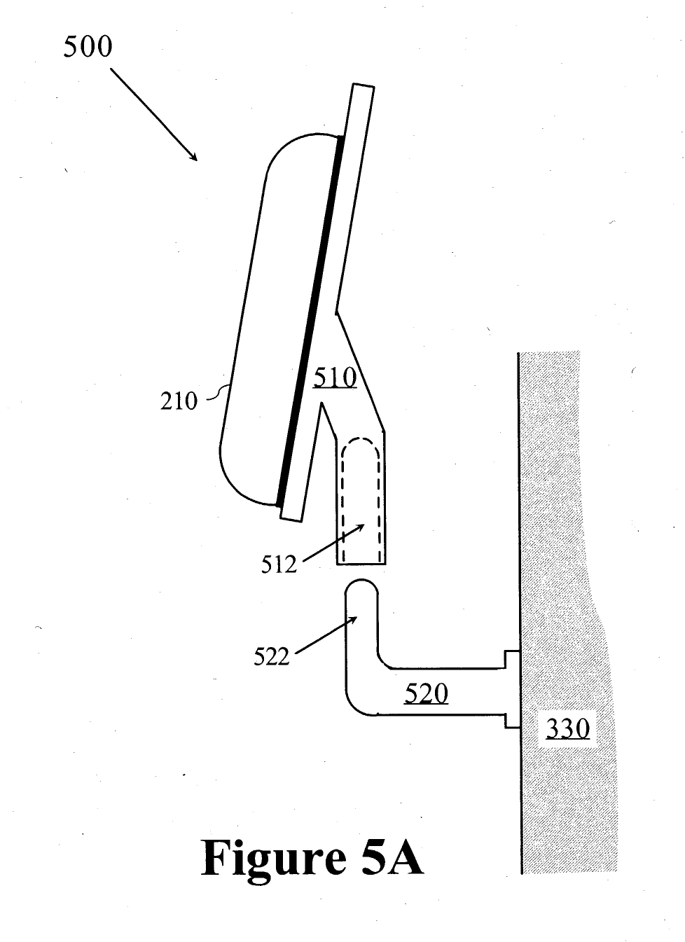

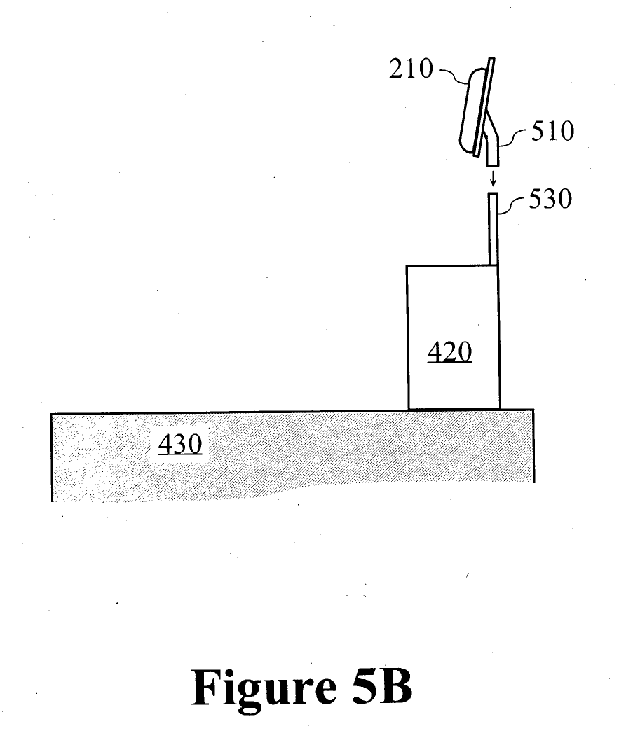

FIG. 5A depicts a third pager securing arrangement 500 according to the present invention similar to the second embodiment of FIGS. 4A and 4B. As shown in FIG. 5A, the third pager securing arrangement 500 includes a pager 210 attached to a first caddy portion 510, and further includes a second caddy portion 520 affixed to wall 330. The first caddy portion 510 includes a tube-like portion 512 configured to fit over a stem portion 522 such that the pager 210 and first caddy portion 510 can be effectively secured to the wall 330.

FIG. 5B depicts the pager 210 and first caddy portion 510 of FIG. 5A used with an alternate second caddy portion 530 integrated into condiment-caddy 420. While the second caddy portion 520 and alternate second caddy portion 530 are depicted as having stem-like portions, it should be appreciated that the first and second caddy portions 510-530 can alternatively be configured into any number of mating/coupling mechanical configurations without departing from the spirit and scope of the present invention.

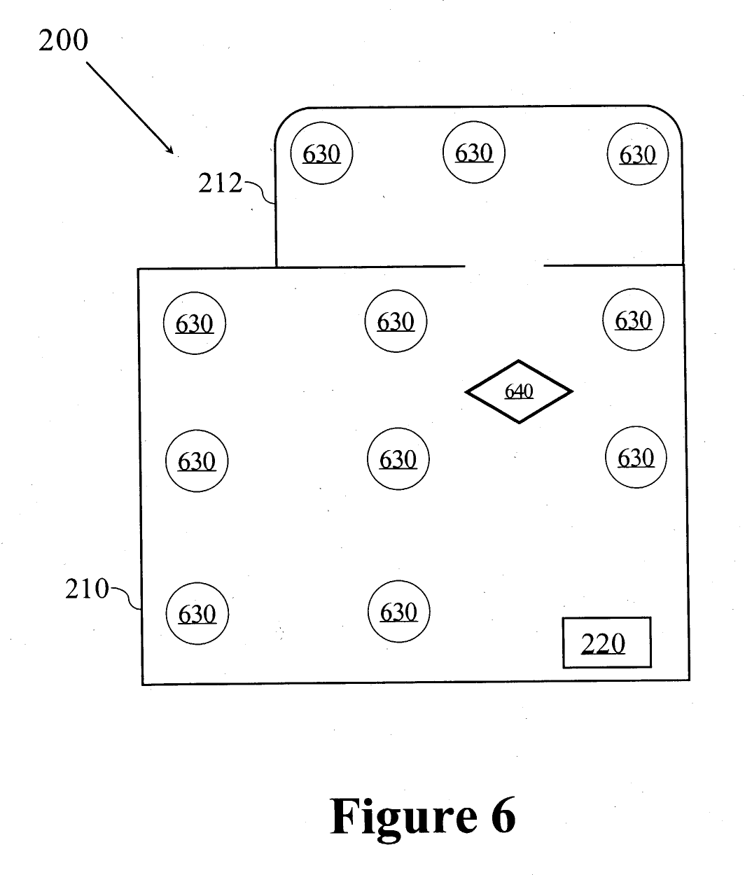

FIG. 6 depicts the exemplary floorplan 200 of FIG. 2 utilizing a second patron locating system according to the present invention. As shown in FIG. 6, the floorplan 200 includes a first room 210, an outdoor courtyard 212 and an operator's station 220. FIG. 6 further depicts a number of low-power wireless transceivers (transmitter/receiver devices) 630 distributed about the floor plan 200 with each transceiver 630 capable of emitting a wireless signal containing an identifying code of a particular portable receiver 640 causing the receiver 640 to activate, i.e., perform some combination of emitting visual cues and transmit a return signal, i.e., act as a transponder.

Such a transponder operation enables the portable receiver 640 to become conspicuous electronically (as opposed to visually conspicuous) in that the transceivers 630 also can be outfitted with wireless sensors configured to sense and locate the return signal provided by receiver 640. Such a return signal can be used to locate the receiver (transponder) 640 via any number of conventional or later developed location means useful to locate mobile electronic devices, e.g., sensing signal strength, triangulation using phase differential, using incorporating GPS information and so forth without departing from the spirit and scope of the present invention.

In operation, a business using this embodiment of present invention can start by distributing a receiver/pager/transponder or some other form of wireless electronic receiving device to each visiting patron. Each patron is then considered to have located himself somewhere randomly in the floorplan area 200. However, instead of each patron placing his pager/transponder in a nearby pager-caddy as discussed above in regard to FIG. 2, the receiver 640 of FIG. 6 derives conspicuousness electronically via a transponder-like return signal provided by the receiver. Accordingly, upon need to locate and/or contact a particular patron, an operator (e.g., a hostess or waiter) can activate the wireless paging activator at station 200 thus causing each of the transceivers 630 to emit a signal containing an identifying code of the particular pager/transponder possessed by the patron of interest. The activated pager/transponder can then emit a return signal that can be electronically sensed and located with the location subsequently displayed to the operator via, e.g., a CRT display provided at the station 220. Upon locating the patron of interest, an agent (e.g., a hostess, waiter or other employee) can be sent to the patron to provide service, information, food or any other product to the patron.

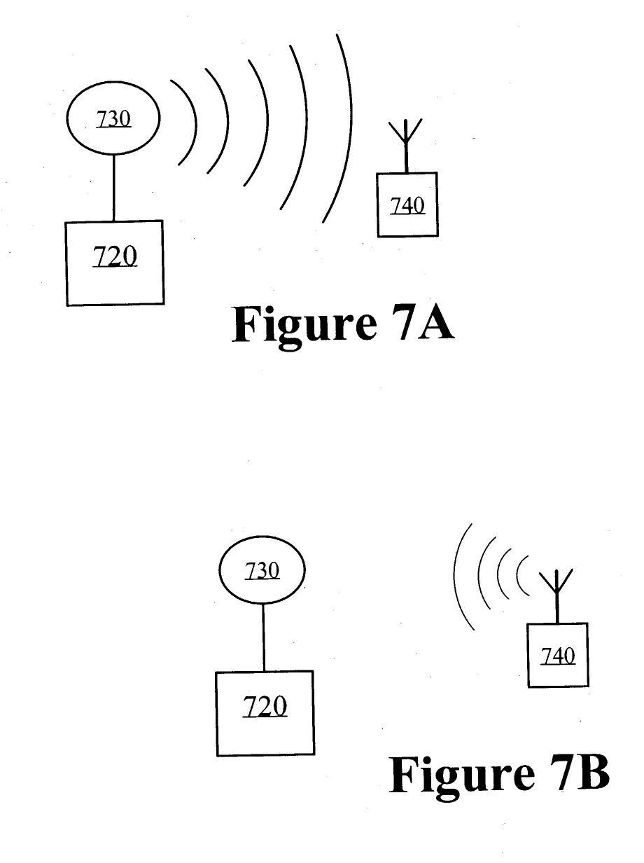

FIGS. 7A and 7B depict a transponder operation with FIG. 7A depicting a first signaling operation where the transceiver 730 (upon instruction from a paging activator 720) emits a wireless signal at a suitable frequency and carrying an embedded identifying code directed to a transponder 740 that will cause the transponder 740 to activate. FIG. 7B depicts the second part of the transponder operation with transponder 740 emitting a return signal that can allow the transceiver 730 (or a multitude of transceivers) to both identify and locate the transponder 740.

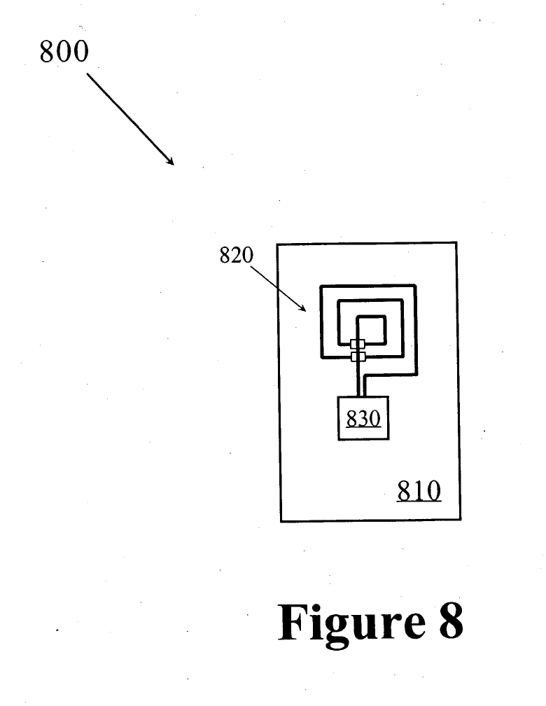

FIG. 8 depicts a RFID 800 useful for transponder operations. While conventionally RFID devices are generally used for anti-shoplifting, product identification and card-reading applications, recent advances in RFID technology have enabled RFID systems to sense and identify battery-less RFID transponders for distances up to 9+ meters from a transceiver using frequencies ranging from 860 Mhz to 930 MHz. While pager frequencies are known within the frequency range of 860 Mhz to 930 MHz, it should be appreciated that these frequencies are not generally used to electronically locate patrons.

Generally, RFID devices are divided into two categories: remotely-powered and locally powered. Remotely-powered RFID devices are differentiated from locally-powered RFID devices and transponders in general in that remotely-powered RFID devices contain no local power source, e.g., a battery, but are instead powered by the energy of the wireless signal used to identify/activate a particular RFID device at an approximate optimal frequency range of about 860 Mhz to about 930 MHz for transfer of energy to RFID devices). That is, remotely-powered RFID devices receive their operational power (as well as possible information and instructions) via a wireless magnetic or electromagnetic signal.

While remotely-powered RFID devices are limited in range as compared to self-powered transponders, use of remotely-powered RFID devices can be advantageous in that more than a hundred-fold cost advantage can be gained per transponder due to the simplicity of design. That is, returning to FIG. 8, the transponder RFID device 800 is depicted as having only three basic components: (1) a single substrate 810, which can be made of inexpensive plastic or even paper; (2) a single integrated circuit 830 adhered to the substrate 810 and (3) a foil antenna 820 also adhered to (or alternatively printed on using conductive ink) the substrate 810 and electrically coupled to the integrated circuit 830.

In contrast to remotely-powered RFID devices, locally-powered RFID devices derive operational power from a local power source, e.g., a battery. While use of a local power source affords a locally-powered RFID device greater range in comparison to remotely-powered RFID devices, locally-powered RFID devices are inherently more expensive and require periodic battery maintenance.

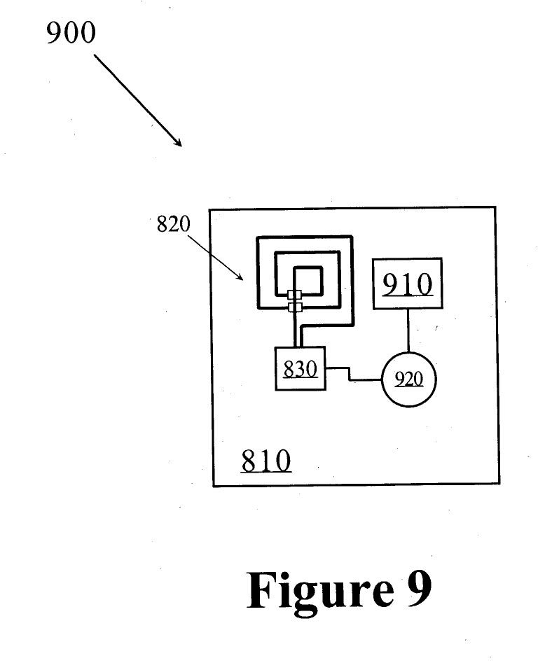

FIG. 9 depicts a remotely-powered RFID variant device 900 having the single substrate 810, integrated circuit 830 and antenna 820 of the first RFID device 800 of FIG. 8, but further including a battery 910 and luminescent display 920. While the remotely-powered RFID variant device 900 uncharacteristically includes a local power source, the integrated circuit 830 of the RFID variant device 900 nonetheless draws its operational power only from a transmitted wireless signal. The battery 910 is only used when the integrated circuit 830 is powered and activated by a wireless signal containing an appropriate identifying code, and even then the battery's power is used only to power the luminescent display 920 (or other device, e.g., speaker, buzzer, other electronic circuitry, etc). By using this RFID variant approach, the integrated circuit 830 draws no operational power (i.e., power required operate the various logic and electronic components) from the battery 910. This allows the RFID variant device to provide a visual display while simultaneously allowing the life-span of the RFID variant device 900 to reach periods extending up to the shelf-life of the battery 930, which for permanently installed lithium-type batteries (including near paper-thin lithium batteries) can exceed five years.

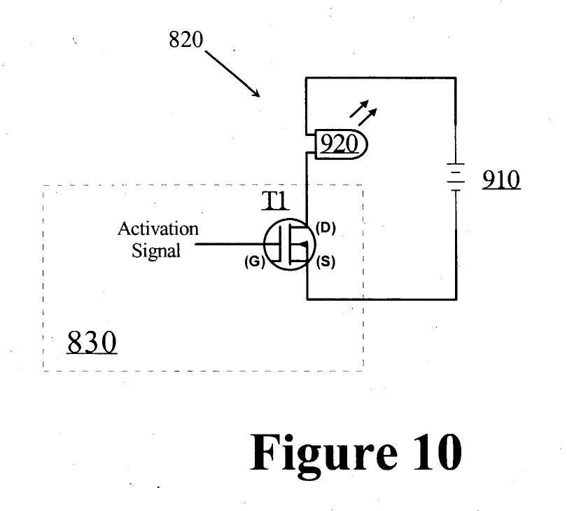

FIG. 10 depicts a portion of the RFID variant 900 of FIG. 9 demonstrating that the luminescent display 920 can be activated via transistor T1 as transistor T1 receives an activation signal. The configuration depicted in FIG. 10 demonstrates that the integrated circuit 830 can operated to light display 820 while the integrated circuit 830 itself uses no operational power derived from battery 910. Further, the configuration of FIG. 10 demonstrates that only a minimal amount of energy (limited to that energy required to charge the gate of transistor T1 to an “on” potential) is required to activate display 920. Still further, during times when transistor T1 is off, no power is drawn from the battery 910 with the possible exception of a very small amount of transistor off-leakage current flowing through transistor T1.

As shown in FIGS. 1-10, the systems and methods of this invention are preferably implemented using dedicated logic or other integrated circuits. However, the systems and methods can also be implemented using any combination of one or more general purpose computers, special purpose computers, program microprocessors or microcontroller and peripheral integrating circuit elements, hardware electronic or logic circuits such as application specific integrated circuits (ASICs), discrete element circuits, programmable logic devices such as Programmable Logic Arrays (PLA), Programmable Read Only Memory (PROM), Field Programmable Gate Arrays (FPGA), Programmed Array Logic (PAL) devices, and/or the like. In general, any device on which exists a finite state machine capable of implementing the various elements of FIGS. 1-10 can be readily or routinely used to implement the patron locating functions of the present invention by the skilled artisan without undue experimentation.

The above description of preferred embodiments is for the purpose of teaching how to practice the invention, and is not intended to detail all of those obvious modifications and variations that will become apparent to a skilled artisan upon reading the description. Such preferred embodiments were chosen or described to exemplify the principles of the invention and enable one of skill in the art to utilize the methods and systems of the present invention with various modifications as would be suited to a particular use as contemplated. It is intended that obvious modifications and variations are within the scope of the following claims.

What is claimed is:

1. A paging system for locating patrons, comprising:
a wireless paging activator;
at least one wireless pager adapted to receive an identifying code from the wireless paging activator;
at least one pager-caddy adapted to hold the wireless pager and affixed to a respective fixture located in a localized area whereby the pager-caddy temporarily holds the wireless pager in a conspicuous location.

2. The paging system of claim 1, wherein the localized area is a restaraunt.

3. The paging system of claim 1, wherein the patrons are customers who have ordered a service or product, and activation of a particular wireless pager communicates to the customer that the ordered service or product is ready.

4. The paging system of claim 1, wherein the patrons are prospective customers waiting to order a service or product, and activation of a particular wireless pager communicates readiness of a provider to provide the service or product.

5. The paging system of claim 2, wherein the fixture may be selected from the group consisting of a wall, a booth, a condiment-caddy and an extension-fixture affixed to a table.

6. A paging apparatus having a high visibility, comprising:
a wireless receiver for receiving an identifying code;
a luminescent display element that activates when the wireless receiver receives an identifying code designating the wireless receiver, the luminescent display element being configured to emit light, and
a securing means configured to temporarily secure the pager to a fixture.

7. The paging apparatus of claim 6, wherein the fixture is located in a conspicuous location.

8. The paging apparatus of claim 6, wherein the securing means is selected from the group consisting of a magnetic mechanism, a grappling mechanism, a clipping mechanism and a matched coupling structures.

9. The paging apparatus of claim 6, wherein the securing means includes a device secured to the fixture and configured to non-adhesively hold the paging apparatus.

10. The paging apparatus of claim 6, wherein the fixture is a wall, a condiment-caddy, a lamp or an extension-fixture affixed to a table.

11. The paging apparatus of claim 9, wherein the paging apparatus is generally disk-shaped.

12. The paging apparatus of claim 11, wherein the paging apparatus is configured to function as a coaster.

13. The paging apparatus of claim 7, wherein the securing means includes a first portion attached to the wireless receiver and a second portion attached to the fixture.

14. The paging apparatus of claim 13, wherein the first and second portions are configured to mechanically couple together.

15. The paging apparatus of claim 13, wherein at least one of the first and second portions include a tube-like structure.

16. A holding device for securing a pager, comprising:
a securing device configured to temporarily secure the pager to a fixture, the pager producing a conspicuous visible signal when activated.

17. The holding device of claim 16, wherein the securing device is fastened to one of a wall, a condiment-caddy and an extension-fixture affixed to a table.

18. A method for locating a particular patron among a plurality of patrons, comprising:
distributing a wireless electronic receiver to each of the plurality of patrons, each wireless receiver having an identifying code;
activating a wireless paging activator configured to emit an identifying code of a particular receiver causing the particular receiver to activate; and
locating the patron possessing the activated receiver based on a conspicuous signal means produced by the activated receiver.

19. The method of claim 18, wherein the activated receiver is a pager and the conspicuous signal means includes one or more luminescent display elements and a fixture configured to temporarily secure the pager.

20. The method of claim 19, wherein the pager is generally disk-shaped.

21. The method of claim 19, wherein the securing device is fastened to one of a wall, a booth, a condiment-caddy, a lamp and an extension-fixture affixed to a restaurant table.

22. The method of claim 19, wherein the plurality of patrons are restaurant patrons.

23. The method of claim 18, wherein the activated receiver is a remotely-powered RFID device, and the conspicuous signal means includes a sensing apparatus capable of providing at least a generalized a location of the activated receiver.

24. The method of claim 23, wherein the remotely-powered RFID device includes a single substrate, a single integrated circuit located on the substrate and an antenna printed on the substrate and coupled to the integrated circuit.

25. The method of claim 23, wherein the remotely-powered RFID device is configured to be attached to an article of clothing.

26. The method of claim 24, wherein the remotely-powered RFID device further includes a single battery and a number of luminescent elements coupled to the integrated circuit.

27. The method of claim 26, wherein the integrated circuit draws essentially no operational power from the battery.

28. The method of claim 26, wherein the integrated circuit receives substantially all operational power from a wireless signal.

29. The method of claim 23, wherein the remotely-powered RFID device operates at a frequency between about 860 MHz to about 930 MHz.
